(19) United States
(12) Patent Application Publication
(10) Pub. No.: US 2002/0000907 A1
(43) Pub. Date: Jan. 3, 2002

(54) SELECTIVE CALL RECEIVER

(76) Inventor: NOBUYA HARANO, TOKYO (JP)

Correspondence Address: SCULLY SCOTT MURPHY AND PRESSER, 400 CARDEN CITY PLAZA, GARDEN CITY, NY, 11530

(21) Appl. No.: 08/808,111

(22) Filed: Feb. 28, 1997

(30) Foreign Application Priority Data
Feb. 29, 1996 (JP) 69484/ 1996

(51) Int. Cl. G08B 5/22

(52) U.S. Cl. 340/7.52; 340/7.39

(57) ABSTRACT

In a selective call receiver, a plurality of received messages are stored onto a message memory until the message memory is full. The received messages have designated degrees, respectively, which are each designated by instructions of a user. When a new received message is received, an earlier received message having the lowest designated degree is retrieved among the received messages stored in the memory and then the new received message is written over the earlier received message having the lowest designated degree.

### BACKGROUND OF THE INVENTION

1. Field of the Invention

The present invention generally relates to a selective call receiver, and in particular to a method and system for managing received messages which are stored in a message memory.

2. Description of the Related Art

A selective call receiver has been widely used for various purposes and, especially, a small-sized and lightweight selective call receiver called a pager is suitable for being taken on the road. A basic function of the selective call receiver is to indicate by beep sound, vibration, or light the incoming call and then to display a received message on an liquid-crystal display (LCD). The received message is stored in a message memory and is read out from the message memory to be displayed on screen according to key operations of a user.

A received message is usually stored onto the message memory until it becomes full. When the message memory reaches capacity, the oldest message is automatically deleted and the latest message is stored. Therefore, a necessary message may be deleted without the user's knowing. On the other hand, in the case where a necessary message is protected, the message is stored in the message memory for indefinitely long time periods until it is deleted by the user consciously, resulting in unnecessarily reduced memory area. Therefore, it is important to decide which message is to be deleted in terms of effective use of the message memory. For this purpose, a selective call receiver having a function of erasing unwanted messages from the message memory by user's operations is disclosed in Japanese Patent Unexamined Publication No. 59-226994. A message is displayed on screen and the user decides whether the message is to be deleted.

SUMMARY OF THE INVENTION

An object of the present invention is to provide a message management method which prevents an important message from erroneous deletion with the effective use of memory.

Another object of the present invention is to provide a selective call receiver which achieves the effective use of a message memory by retaining only important messages.

According to the present invention, a plurality of received messages are stored onto a memory until the memory is full. The received messages have designated degrees, respectively, which are each designated by instructions of a user. When a new received message is received, an earlier received message having a lowest designated degree is retrieved among the received messages stored in the memory and then the new received message is stored over the earlier received message having the lowest designated degree. Each of the designated degrees may be one of a plurality of importance degrees or one of a locking degree and a plurality of importance degrees which are lower than the locking degree. Since the message having the lowest degree is erased and the new message is written, an important message is prevented from erroneous deletion and the effective use of memory is achieved.

### BRIEF DESCRIPTION OF THE DRAWINGS

FIG. 1 is a functional block diagram showing an embodiment of a radio selective call receiver according to the present invention;

FIG. 2 is a flowchart showing a write-over routine of an embodiment of a message management method according to the present invention;

FIG. 3 is a flowchart showing a lock and importance designation routine of the embodiment of the message management method; and

FIG. 4 is a schematic diagram showing an example of a display screen according to the embodiment of the message management method.

### DETAILED DESCRIPTION OF THE PREFERRED EMBODIMENTS

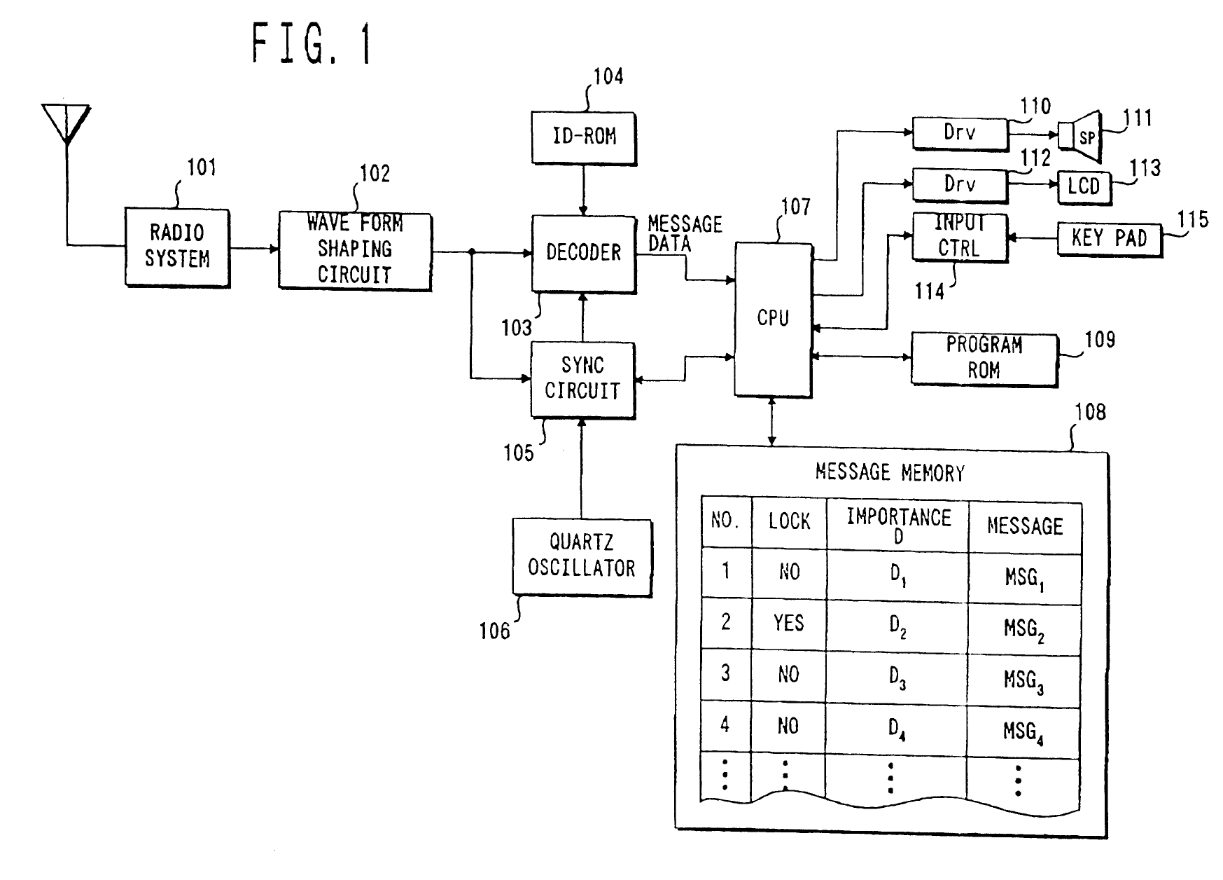

Referring to FIG. 1, there is shown a selective call receiver in accordance with the present invention. The selective call receiver is provided with a radio system 101 which receives a radio signal from a radio base station (not shown) of a selective calling system through an antenna. The radio system 101 includes a demodulator which demodulates the received radio signal into a baseband signal. After the waveform of the baseband signal is shaped by a waveform shaping circuit 102, the baseband signal is transferred to a decoder 103 and a sync circuit 105.

The decoder 103 decodes the baseband signal into received data according to a sync timing signal received from the sync circuit 105 and compares a selective calling number included in the received data with an identification (ID) number which is previously stored in an ID ROM 102. The sync circuit 105 detects synchronization from the baseband signal and produces the sync timing signal using a reference oscillation signal which is generated by a quartz oscillator 106. When the selective calling number is identical to the ID number, that is, an incoming call occurs, a received message data MSG included in the received data is stored onto a message memory 108 together with lock or importance designation information under the control of a processor 107, which will be described in detail. The processor 107 controls the receiver operations according to a program stored in a program ROM 109.

The message memory 108 stores a plurality of received messages MSG₁, MSG₂, . . . , which are each accompanied by degrees of importance, D₁, D₂, . . . , or lock information in table form. For example, the highest degree of importance is represented by D=4 and the lowest degree of importance is rep resented by D=0 which means that neither lock nor importance is designated. The lock information YES or No may be indicated by a lock flag being 1 or 0. It is also possible that the lock flag and the degree of importance is combined into a designated degree. More specifically, the designated degree consists of the lock flag as themost significant bit (MSB) followed by the degree of importance D because the degree of the locking may be higher than any of the degrees of importance.

The selective call receiver is further provided with a speaker driver 110 and a speaker 111 for informing a user of an incoming call. An LCD driver 112 and an LCD 113 are provided to display messages and other information on screen. Furthermore, the processor 107 is connected to an input controller 114 which controls a keypad 115 to receive instructions including lock and importance designation from the user. When an incoming call occurs, the processor 107 controls the speaker 111 to make a beep. Further, when receiving a read request from the keypad 115, the processor 107 reads a designated message from the message memory 108 and then sends the message to the LCD driver 112 to display it on the LCD 113.

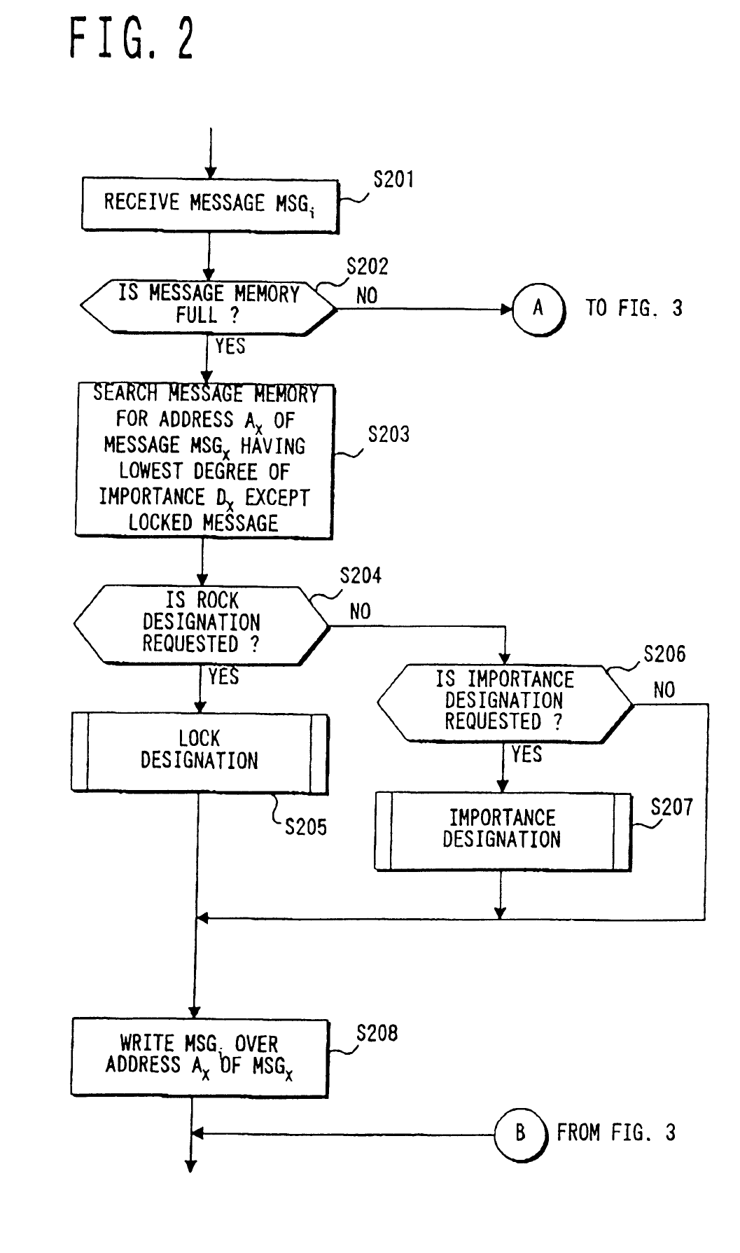

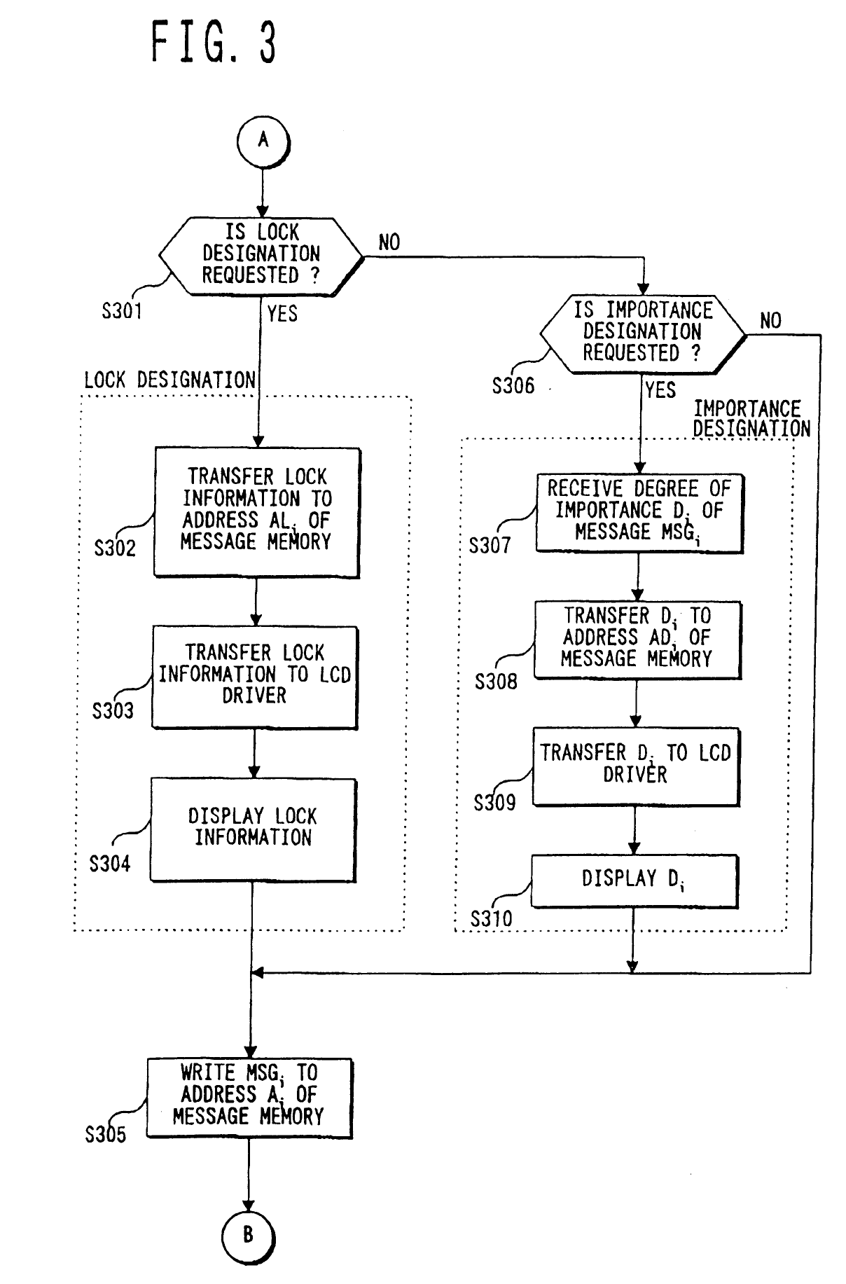

Referring to FIG. 2, when a selective calling number of the received data is coincident with the ID number, the processor 107 receives a received message MSGᵢ from the decoder 103 and displays the message MSGᵢ on the LCD 113 (step S201). When receiving the received message MSGᵢ, the processor 107 checks whether the message memory 108 is full (step S202). In the case where the message memory 108 is full (YES of step S202), the processor 107 searches the message memory 108 for the lowest degree of importance Dx of a message MSGx except a locked message and reads the address Ax of the lowest important message MSGx (step S203). If two or more lowest important messages are found, the earliest one may be selected. In the case where the message memory 108 is not full (NO of step S202), lock designation or importance designation is performed as will be described referring to FIG. 3. As described before, in the case where the lock information and the degree of importance is combined into a designated degree, the processor 107 can retrieve the lowest important message MSGx by only searching the designated degrees stored in the message memory 108.

Subsequently, when the lock designation is requested by the user (YES of step S204), the lock designation is performed (step S205). When the lock designation is not requested but the importance designation (NO of step S204 and YES of step S206), the importance designation is performed (step S207). The lock designation routine (S205) and the importance designation routine (S207) will be described in detail referring to FIG. 3. After the lock designation or the importance designation is performed, the processor 107 writes the received massage MSGi over the address Ax of the lowest important message MSGx (step S208). In this manner, when the message memory 108 is full, the lowest important message MSGx is deleted from the message memory 108 and the new message MSGi is written onto the message memory 108.

Referring to FIG. 3, when the message memory 108 is not full (NO of step S202), the rock designation or the importance designation is performed. In the case where the lock designation is requested by the user (YES of step S301), the lock designation steps S302-S304 are performed. More specifically, when the user requests the locking of the message MSGi through the keypad 115, the processor 107 transfers the lock information (YES) to an address ALi for lock information of the message memory 108 (step S302). Further, the lock information is transferred to the LCD driver 112 (step S303) and is displayed on the LCD 113 (step S304) and thereby the user can confirm the locking of the message MSGi. After that, the message MSGi is stored at a message address Ai of the message memory 108 (step S305).

When the lock designation is not requested but the importance designation (NO of step S301 and YES of step S306), the importance designation steps S307-S310 are performed. More specifically, when receiving the degree of importance Di of the message MSGi from the keypad 115 (step S307), the processor 107 transfers the importance information Di to an address ADi for importance information of the message memory 108 (step S308). Further, the importance information Di is transferred to the LCD driver 112 (step S309) and is displayed on the LCD 113 (step S310) and thereby the user can confirm the degree of importance Di given to the message MSGi. After that, the message MSGi is stored at a message address Ai of the message memory 108 (step S305).

When the importance designation is not requested (NO of step S306), the message MSGi is stored at a message address Ai of the message memory 108 (step S305) without lock or importance designation. In this case, the lowest degree of importance is given to the message MSGi. Therefore, if anew message is received in the case of the message memory 108 being full, the new message is written over that lowest important message MSGi.

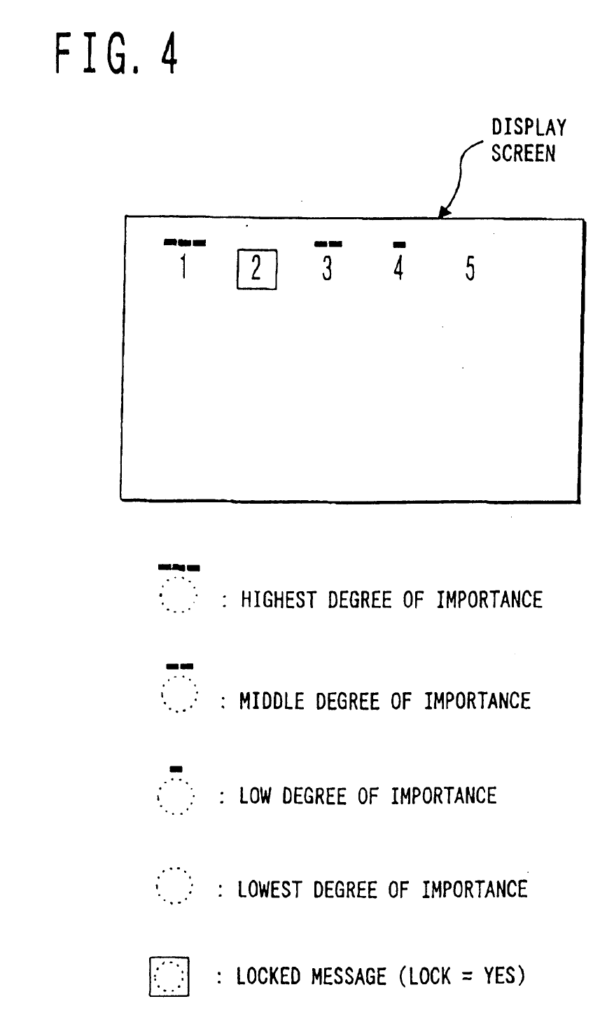

As shown in FIG. 4, as an example, the degree of importance may be indicated by the number of lines or dots and the lock information may be indicated by a box around a message number.

What is claimed is:

1. A method for managing messages stored in a memory in a selective call receiver having a display, comprising the steps of:
a) storing a plurality of received messages onto the memory until the memory is full, the received messages having designated degrees, respectively, and the designated degrees being designated by an instruction of a user; and
b) storing a new received message over an earlier received message having a lowest designated degree among the received messages stored in the memory.

2. The method according to claim 1, wherein the new received message is stored together with a designated degree designated by an instruction of the user.

3. The method according to claim 2, wherein each of the designated degrees is one of a plurality of importance degrees.

4. The method according to claim 2, wherein each of the designated degrees is one of a locking degree and a plurality of importance degrees which are lower than the locking degree.

5. The method according to claim 2, wherein the memory comprises a table where the received messages and the designated degrees thereof are stored with each received message corresponding a designated degree.

6. The method according to claim 2, wherein the step (a) comprises:
displaying a received message on the display;
designating a degree of the received message by an instruction of the user; and
storing the received message and a designated degree thereof onto the memory.

7. The method according to claim 6, wherein the designated degree is one of a plurality of importance degrees.

8. The method according to claim 6, wherein the designated degree is one of a locking degree and a plurality of importance degrees which are lower than the locking degree.

9. The method according to claim 2, wherein the step (b) comprises:
retrieving the lowest designated degree from the designated degrees stored in the memory; and
writing the new received message over the earlier received message having the lowest designated degree.

10. The method according to claim 9, wherein each of the designated degrees is one of a plurality of importance degrees.

11. A selective call receiver for receiving a selective calling signal including a message, comprising:
a memory for storing a plurality of received messages which have designated degrees, respectively, and the designated degrees being designated by an instruction of a user; and
a controller for controlling such that, when the memory is full, a received message is stored over an earlier received message having a lowest designated degree among the received messages stored in the memory.

12. The selective call receiver according to claim 11, further comprising:
a display; and
an input keypad for inputting an instruction of a user,
wherein the received message is stored together with a designated degree designated by an instruction of the user.

13. The selective call receiver according to claim 12, wherein the controller retrieves the lowest designated degree from the designated degrees stored in the memory, and writes the received message over the earlier received message having the lowest designated degree.

14. A method for managing messages stored in a memory in a selective call receiver having a display, comprising the steps of:
a) displaying a received message on the display;
b) designating a degree of the received message by an instruction of the user;
c) storing the received message and a designated degree thereof onto the memory;
d) repeating the steps (a) to (c) until the memory is full;
e) retrieving the lowest designated degree from the designated degrees stored in the memory when a new received message is received; and
f) writing the new received message over an earlier received message having the lowest designated degree.

15. A memory provided in a selective call receiver, the memory storing a program comprising the steps of:
a) displaying a received message on the display;
b) designating a degree of the received message by an instruction of the user;
c) storing the received message and a designated degree thereof onto the memory;
d) repeating the steps (a) to (c) until the memory is full;
e) retrieving the lowest designated degree from the designated degrees stored in the memory when anew received message is received; and
f) writing the new received message over an earlier received message having the lowest designated degree.
